(19) United States
(12) Patent Application Publication
(10) Pub. No.: US 2019/0338484 A1
(43) Pub. Date: Nov. 7, 2019

(54) METHOD FOR EARLY DETECTION OF THE RISKS OF FAILURE OF A NATURAL OR MAN-MADE STRUCTURE

(71) Applicant: OSMOS GROUP, Paris (FR)

(72) Inventor: Bernard HODAC, Paris (FR)

(21) Appl. No.: 16/313,740

(22) PCT Filed: Jun. 27, 2016
(86) PCT No.: PCT/FR2016/051574

§ 371 Date: Dec. 27, 2018

(51) Int. Cl. E02D 1/08; E02D 37/00; G01V 8/24

(52) U.S. Cl. CPC E02D 1/08; E02D 2600/10; G01V 8/24; E02D 37/00

(57) ABSTRACT

A building rests on the soil. Vertical elongation detectors are placed at the base of pillars above bearing points of the building on the soil, in particular at the corners of the building. Variations in the measurements of vertical elongation of the pillars indicate a variation in the ability of the soil to support the building. In particular, the partial or total unloading of a pillar gives rise to suspicion of a compaction of the soil under the pillar.

The present method is usable for very early detection of risk situations that might eventually compromise the safety of a structure.

The present invention relates to a method for the early detection of the risks of failure of a natural or man-made structure, in particular as a result of the geological conditions prevailing beneath the structure.

In general, a man-made structure, such as buildings or civil engineering structures, is intrinsically very reliable if it has not developed any failures within the few years after the beginning of its service life. The greatest risk is thus associated with the weaknesses or deteriorations of the soil bearing the structure. Subsidence, swelling and other deformations, ground movements and variations in mechanical strength etc. may occur.

These changes in the mechanical characteristics beneath the structure are likely to weaken and damage the structure, and to make it dangerous.

A similar set of problems can affect certain natural structures such as rock structures, for example a cliff the base of which is exposed to erosion.

A purpose of the present invention is to propose a simple, effective and reliable method for very early detection of situations which endanger at least one structure owing to a change that has occurred beneath the structure.

According to the invention, the method for the early detection of risks of failure of a natural or man-made structure, in particular as a result of the geological conditions prevailing beneath the structure, is characterized in that an elongation detector is placed on the structure directly above each of several bearing points of the structure, and a change in the soil underlying the structure is diagnosed, at least in certain cases in which the elongations detected indicate a change in the distribution of the vertical loads between said several bearing points.

When the soil underlying the structure is stable and robust, the vertical elongation detectors give a stable indication, which is a function of the load that the structure applies to the soil at each of the several bearing points, respectively. Said load is mainly constituted by the portion of the weight of the structure that is applied to the respective bearing point. In general, the load is different at each of the several bearing points. If the conditions under which the structure rests on the soil now deteriorate, in general the deterioration affects the foundation of the structure differently under the different bearing points. The distribution of the load over the different bearing points is modified. The supports resting on a more load-bearing soil are subjected to a greater load and the other supports are unloaded correspondingly. This is detected by the elongation detectors.

Preferably, the detectors are vertical elongation detectors. The detection according to the invention is thus particularly effective and the interpretation of the detection results is facilitated.

Typically, a tendency to compaction or collapse is diagnosed beneath a bearing point where the measured elongation has increased, and/or a tendency to swelling is diagnosed beneath a bearing point where the measured elongation has decreased.

When the structure is a building or similar, the vertical elongation detectors are preferably placed at the base of load-bearing pillars, in particular corner pillars of the structure. This has the dual advantage of placing the detectors in locations which concentrate the loading stresses due to the weight of the structure, and increasing the sensitivity to variations in the geological conditions by separating the detectors as far from each other as possible.

In other types of structures, it is difficult to identify pillars or other localized bearing points. This is the case for example for a cylindrical tank having a vertical axis, for example of the type used in the oil or petrochemical industry. The elongation detectors, preferably vertical elongation detectors, are then distributed all around the base of the tank or other comparable structure with, for example, a detector every 10-20 metres.

When the structure comprises a raft foundation forming a support base on the soil, the detectors are preferably horizontal elongation detectors which are placed on the raft foundation in order to detect bending and/or shearing variations of the raft foundation. Structures equipped with a raft foundation are generally very large structures, of the civil engineering type, that are too heavy to be directly anchored in the soil. When equipping the raft foundation of the structure with the detectors according to the invention, they are placed as close to the soil as possible, which is preferable. But in certain cases of existing structures, the raft foundation is no longer accessible, or access is too difficult. In such a case, it is possible to equip the structure above the raft foundation, as close as possible to the raft foundation, in the manner of the building pillars or peripheral sites of the tank, i.e. preferably with vertical elongation detectors.

In a version of the method, each elongation detector comprises an optical fibre extending in the elongation direction to be detected, and means sensitive to the weakening of a light intensity received at one end of the optical fibre with respect to the strength of a light source supplying the other end of the optical fibre. This type of elongation detector is particularly advantageous because of its low cost, its immediate response to the length variations which even make it possible to detect vibration phenomena, for example of the seismic type, and at the same time, its long-term reliability which makes it possible to reliably compare measurements that are spaced out over time. Thus, both a precise history of the events which are the cause of a change, and precise measurements of the consequences of this change are obtained.

Preferably, the optical fibre is pre-tensioned so that said weakening is also modified in the case of shortening of the optical fibre. When the load borne by a support increases, it causes compaction of the structure above this support. Due to the pre-tensioning, the vertically installed fibre retracts on itself by means of elastic recovery when the zone in which it is installed is compacted. The compaction is thus accurately signalled by the elongation detector. A pre-tensioned fibre installed horizontally signals by the shortening thereof for example a bending such that the optical fibre is found in the zone in which this bending compresses the support material, for example the material of the raft foundation.

In an advantageous version, the measurements and their date are recorded in order to obtain dated elongation measurements and a timing chart of the elongation measurements. This version is particularly interesting with a faithful elongation detector such as a detector for measuring the weakening of the light along an optical fibre, as presented above.

It is particularly informative to cross-check the dated elongation measurements with information on dated known events that have modified the loading of the structure above the supports equipped with elongation detectors. Sometimes structures undergo major modifications which have a significant effect on the loading at the level of the supports of the structure. For example, a swimming pool is created on the roof of the building, or another floor is added, a hanging garden is created on a terrace etc. A comparative study, in terms of dates and size, of such modifications and certain elongation variations detected according to the invention, makes it possible to determine whether the variations are consistent with the modifications carried out or, conversely, probably have another cause.

It is also advantageous to cross-check the dated elongation measurements with the dated elongation measurements obtained on another structure, above the bearing points of the latter. The simultaneity of variations noted on the two structures can make it possible to diagnose soil variations affecting a larger area than that on which the structure rests.

By cross-checking the dated elongation measurements with dated meteorological data, it is possible to explain elongation variations by means of meteorological phenomena that took place in the same period, for example a temporary swelling of the soil following heavy rains, stress on the structure exerted by heavy winds that have influenced the distribution of the loads at the level of the supports of the structure etc.

Advantageously, it is also possible to cross-check the dated elongation measurements with dated seismic data. Thus, it is possible to explain elongation variations by means of seismic phenomena having affected the region.

In all the preceding cases, the use of accurate elongation detectors such as the detectors for measuring the weakening of the light in an optical fibre, make it possible to both identify the cause of variations and to know whether these causes have only temporarily modified the loads or, conversely, have had more or less serious consequences making it necessary to take appropriate measures.

A measure that can be taken when a deterioration of the underlying soil has been diagnosed can be to carry out rebalancing and/or reinforcement of the underlying soil. It is possible for example to inject materials under the structure into the zone in which the support of the structure is weakened, or also to place reinforcing elements therein, such as underpinning piles.

During such operations or similar corrective operations, it is advantageous to control the rebalancing or reinforcement operations towards restoring the elongations to the values prior to the deterioration. In other words, the degree of reinforcement can be set so as to restore the prior values, for example injecting material progressively while monitoring the change in the elongations, then stopping the injection when the prior values have substantially been restored.

In the case of a seismic phenomenon, the elongation values before and after the phenomenon are compared in order to determine whether the structure and/or the underlying soil have been permanently affected by the seismic phenomenon. This is made possible by elongation detectors such as those measuring the weakening of light in an optical fibre, which not only report on the vibration phenomena, like a seismograph, but also the long-term variations, which a seismograph does not do.

In an advantageous version of the method, at least one neighbouring structure is inspected when a change is detected underlying the structure equipped with the elongation detectors. Thus, a structure equipped according to the invention can serve as a detector for other structures that are not equipped but which are considered to be likely to be affected by a ground defect observed by means of the equipped structure.

Preferably, in the case where the structure is a building, the detectors are distributed over the perimeter of the building, preferably at the corners of the building. For a building of relatively small size, for example with a length of 20 m, it is generally sufficient to provide an elongation detector at the four corners (quadrangular building) or four detectors distributed over the perimeter of a building of a more complex shape but having dimensions comparable to those of the above-mentioned quadrangular building. For larger buildings, it is generally possible to place detectors in a manner distributed between the corners, in addition to the detectors at the corners. For example, on a building with a length of 40 m, in addition to the detectors at the corners, a detector is typically placed in the middle of each of the long sides.

Other features and advantages of the invention will become apparent from the description below, relative to examples which are in no way limitative.

In the attached figures:

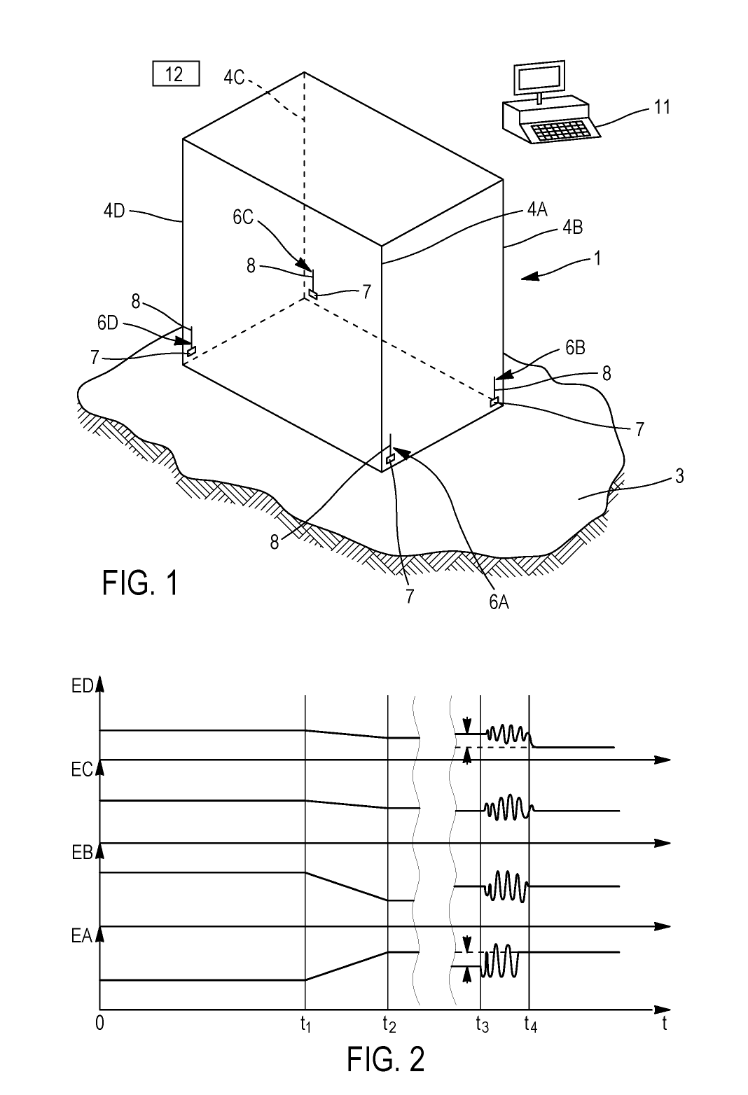

FIG. 1 is a diagrammatic perspective view of a building equipped with elongation detectors according to the invention, for implementing the method according to the invention;

FIG. 2 is a timing chart of the elongation data obtained with the four detectors of the building in FIG. 1, in the cases of two events having affected the resting conditions of the building on the underlying soil;

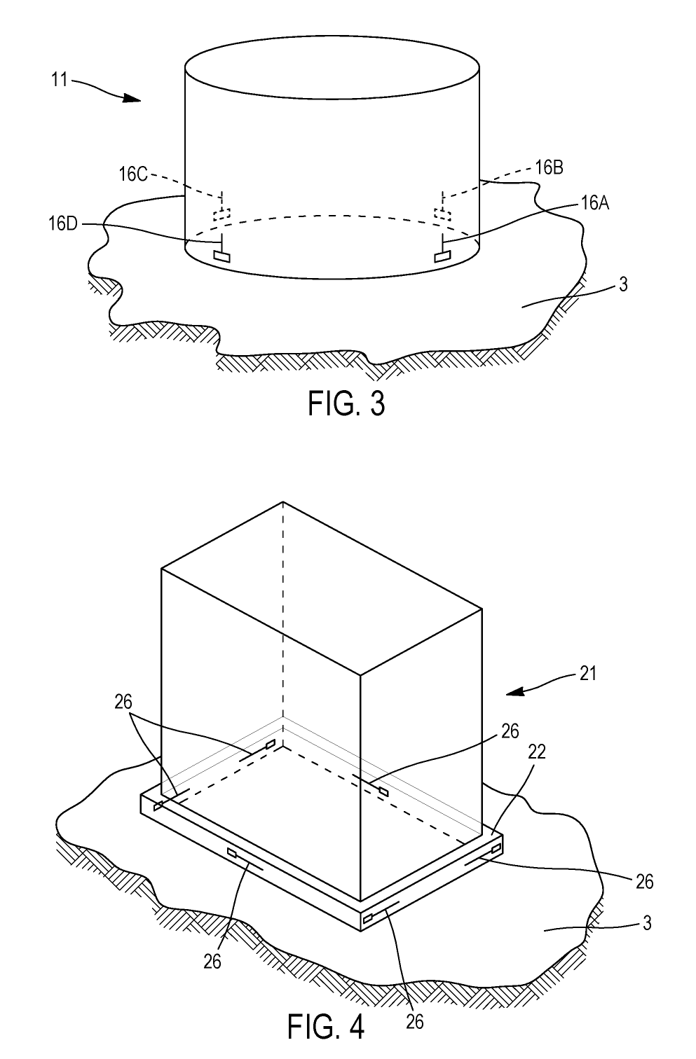

FIG. 3 is a diagrammatic perspective view of a cylindrical tank equipped with elongation detectors according to the invention, for implementing the method according to the invention; and

FIG. 4 is a perspective view of a structure comprising a raft foundation equipped with elongation detectors according to the invention, for implementing the method according to the invention.

As these embodiments are in no way limitative, variants of the invention can in particular be considered comprising only a selection of the characteristics described hereinafter, in isolation from the other characteristics described (even if this selection is isolated within a phrase containing these other characteristics), if this selection of characteristics is sufficient to confer a technical advantage or to differentiate the invention with respect to the state of the prior art. This selection comprises at least one, preferably functional, characteristic without structural details, and/or with only a part of the structural details if this part alone is sufficient to confer a technical advantage or to distinguish the invention over the state of the prior art.

In the example shown in FIG. 1, the structure is a rectangular building 1 that is located in a known manner in an underlying soil 3.

In this example, the building is a block of flats that is parallelepiped in shape with a rectangular base, the length of which is for example 20 m. In a manner that is in itself conventional, the building is structured around vertical reinforcements—or pillars—4A, 4B, 4C, 4D at its corners. These pillars are quite particularly intended to transmit to the soil at least a portion of the load constituted by the weight of the building. In this conventional example, the four pillars of the building thus form, at their base, supports on the soil 3. In practice, the corner pillars 4A, 4B, 4C, 4D can be found slightly recessed inside the building and not directly visible from the outside, FIG. 1 being simplified in this respect for greater clarity.

According to the invention, a respective elongation detector 6A, 6B, 6C, 6D has been placed directly above each of these supports, along the pillars. By “directly above” is meant at a vertical distance from the actual support, short enough for the detector to be directly influenced by the entire load transmitted to the soil by this support. The detectors have been diagrammatically shown on the outer face of the building but mounting on an inside or side face of the pillars is also possible.

In the example shown, each detector is a vertical elongation detector.

Preferably, each detector comprises an optical fibre 8 which extends in the detection direction, here the vertical direction. The fibre is fastened to the structure (to the pillar) so as to extend and shorten in the same manner as the zone of the pillar where it is fastened. The elongation detector also comprises a light source (not shown) that injects light at one end of the optical fibre, and a light sensor (not shown) sensitive to the transmitted light, i.e. the light arriving at the other end of the optical fibre having passed through the entire length of the optical fibre. In a known manner, by comparison with a reference state of the optical fibre, corresponding for example to its state at the time of its installation, when the optical fibre undergoes stretching with respect to its reference state, the sensor detects increased weakening of the transmitted light intensity with respect to the light intensity of the source. Conversely, when the optical fibre is compressed longitudinally or is entirely or partially relaxed from its reference stretch, the sensor detects less weakening of the light intensity transmitted with respect to the light intensity of the source. Thus, the light sensor provides a measurement signal indicating the length and variations in length of the support of the optical fibre, here the vertical length of a lower zone of the pillar where the optical fibre is fastened. In order for the fibre to be reliably shortened if the support, here the pillar, is compacted, it is known to pre-tension the fibre during its fastening to the support such that in the event of compaction of the support, the fibre reacts by means of an elastic relaxation reducing its pre-tensioned state.

Each optical fibre 8 is connected to a box 7 in which is typically found both the light source and the light sensor. In this case, the fibre is folded in the middle such that the two ends thereof are adjacent, the folded middle of the fibre being found at the end of the device opposite the box. The box 7 contains a transmitter that transmits the results of the detection to a computer 11 making it possible to visualize and record the results. The mode of transmission between the boxes 7 and the computer 11 can take several forms, for example wireless transmission to a central box 12 installed in the building 1 or close by, and capable of communicating via the Internet and/or by GPRS and/or other means with the computer 11.

FIG. 2 shows an example of results obtained such that they can for example be visualized by means of the computer 11 in FIG. 1. Four timing charts can be seen, namely those of the elongations EA, EB, EC, ED read by the detectors 6A, 6B, 6C, 6D respectively, as a function of the time t.

Between the time points t1 and t2, an event takes place that greatly increases the elongation EA, more weakly decreases the elongations EB and ED, while the elongation EC is hardly affected. This means that the pillar 4A has been significantly unloaded, the pillars 4B and 4D have been further loaded and the pillar 4C has a load that is substantially unchanged. After the time point t2, the elongation states EA, EB, EC, ED remain stable at the new values.

In the absence of modifications taking place to the block of flats itself between the time points t1 and t2, it can be concluded that the soil 3 has been compressed under the pillar 4A which thus becomes unable to transmit the weight of the building to the soil as efficiently as before, and the weight of the building is partially transferred to the adjacent pillars 4B and 4D, which are thus further compressed.

According to the invention, first it is checked if these variations of the distribution of the load have damaged the building. If necessary, the building is made safe by means of temporary reinforcements, and/or the building is evacuated. Then, if the building can be repaired, or if it is not damaged, the soil 3 under the building is reinforced, for example by injecting the appropriate materials therein, in particular under the pillar 4A. Preferably, at the same time as the injection is carried out, the change of the elongations 4A, 4B, 4C and 4D is monitored with the aim of restoring the values prior to the time point t1. When this is reached, the injection is stopped. Other corrective measurements can constitute placing new piles under the building, in particular in the zone of the pillar 4A. The definitive repair of the building can then take place, for example repair of fissures, installation of definitive reinforcements etc.

In the right portion of FIG. 2 is shown an example of observations that can be made in the case of an earthquake taking place between the time points t3 and t4. The detectors preferably used according to the invention, operating by measuring the weakening of the light transmitted by an optical fibre, take account of both the vibration phenomena of the earthquake in real time and the consequences of the earthquake in the form of the elongations EA and ED which stabilize at values that are different from those before the earthquake. The process of inspection and repair of the building is then substantially the same as in the previous example.

In the example shown in FIG. 3, the structure is a tank 11 of large dimensions having a vertical axis, of the type used in oil installations. There are no structural elements where the load is concentrated. The vertical elongation detectors 16 are distributed at various points, here four points, distributed over the perimeter of the base of the side wall of the tank.

In the example shown in FIG. 4, the structure 21, shown in the diagrammatic shape of a parallelepiped like structure 1 in FIG. 1, this time comprises a raft foundation 22 forming a support base on the soil 3. In this case, horizontal elongation detectors 26 have been placed at points distributed over the perimeter of the raft foundation 22. In the example shown the detectors 26 are placed on the side surfaces of the raft foundation but installation on the upper face thereof, in particular all around the structure 21 itself, can also be envisaged.

Of course, the invention is not limited to the examples described and shown.

1. A method for the early detection of the risks of failure of a natural or man-made structure, in particular as a result of the geological conditions prevailing beneath the structure, comprising: placing an elongation detector on the structure directly above each of several bearing points of the structure; and a change in the soil underlying the structure is diagnosed, at least in certain cases where the elongations detected indicate a change in the distribution of the vertical loads between said several bearing points.

2. The method according to claim 1, characterized in that the detectors are vertical elongation detectors.

3. The method according to claim 2, characterized in that when the structure is a building or similar, the vertical elongation detectors are placed at the base of load-bearing pillars, in particular corner pillars of the structure.

4. The method according to claim 2, characterized in that a tendency to compaction is diagnosed below a support where the measured elongation has increased.

5. The method according to claim 2, characterized in that a tendency to swelling is diagnosed below a support where the measured elongation has decreased.

6. The method according to claim 1, characterized in that in the case of a structure comprising a raft foundation, the detectors are horizontal elongation detectors that are placed on the raft foundation.

7. The method according to claim 1, characterized in that each elongation detector comprises an optical fibre and means sensitive to the weakening of a light intensity received at one end of the optical fibre with respect to the strength of a light source supplying the other end of the optical fibre.

8. The method according to claim 1, characterized in that the optical fibre is pre-tensioned so that said weakening is also modified in the case of shortening of the optical fibre.

9. The method according to claim 1, characterized in that the measurements and their date are recorded in order to obtain dated elongation measurements and a timing chart of the elongation measurements.

10. The method according to claim 1, characterized in that the dated elongation measurements are cross-checked with information on dated known events that have modified the loading of the structure above the supports equipped with elongation detectors.

11. The method according to claim 1, characterized in that the dated elongation measurements are cross-checked with dated vertical elongation measurements obtained on another structure, above supports of the latter.

12. The method according to claim 1, characterized in that the dated elongation measurements are cross-checked with dated meteorological data.

13. The method according to claim 1, characterized in that the dated elongation measurements are cross-checked with dated seismic data.

14. The method according to claim 1, characterized in that rebalancing and/or reinforcement of the substrate and/or of the soil underlying the structure is carried out when a change in the underlying soil is diagnosed.

15. The method according to claim 14, characterized in that the rebalancing or reinforcement operations are controlled towards restoring elongations to the values prior to the deterioration.

16. The method according to claim 1, characterized in that in the case of a seismic phenomenon, the elongation values before and after the phenomenon are compared in order to determine whether the structure and/or the underlying soil have been permanently affected by the seismic phenomenon.

17. The method according to claim 1, characterized in that at least one neighbouring structure is inspected when a change is detected in the soil underlying the structure equipped with the elongation detectors.
